(19) United States
(12) Patent Application Publication
(10) Pub. No.: US 2004/0118306 A1
(43) Pub. Date: Jun. 24, 2004

(54) Disposable printing roller

(76) Inventors: Eeik S. Larson, Norwood, MA (US); William Edward Mansfield JR., Sandwich, MA (US)

Correspondence Address: Thomas E. Hagar, 129 Boston Post Road, Wayland, MA, 01778, US

(21) Appl. No.: 10/327,478

(22) Filed: Dec. 20, 2002

(51) Int. Cl. B41F 13/10

(52) U.S. Cl. 101/375

(57) ABSTRACT

The invention relates to printing rollers that are used in the flexographic industry. Presently there are no cost effective disposable printing rollers designed for use in printing presses used in the flexographic industry. The invention comes in different designs depending on the particular press involved. The invention can be manufactured and sold at a cost similar to the resurfacing costs of the present non-disposable printing rollers. The invention provides the convenience of being disposable saving time and cost to the printer. The high administrative and logistic costs associated with resurfacing printing rollers are eliminated with the present invention. One need only use the disposable printing roller once and simply dispose of it once the roller is no longer useful.

### BACKGROUND

a) Field of the Invention

This invention relates to the industry of printing rollers used in the offset printing industry. More specifically, the invention relates to printing rollers used in the flexographic printing industry. The invention is a disposable printing roller designed to replace the present printing rollers in the industry that are presently non-disposable. Presently there is a need in the flexographic industry for a low cost disposable printing roller.

b) Description of the Related Art

The flexographic industry uses offset printing techniques to print on a variety of surfaces such as cups, containers, buckets, lids, etc. Two typical configurations of an offset printer are displayed in FIGS. 1 and 2. The printing ink is metered through a series of rollers and drums (12 through 22) from an ink well 24 to a printing drum 10 which is typically referred to as a plate cylinder. The type of printing press in FIG. 1 consists of a combination of seven rollers and drums. The first roller 20, commonly called a ductor roller, removes ink from the ink well 24. The ink is then transferred from the ductor roller 20 to a pair of idler rollers, an upper idler roller 18 and a lower idler roller 16. The ink is transferred to a drum 22 and then onto two form rollers, an upper form roller 12 and a lower form roller 14. The two form rollers then transfer a preset amount of ink on to the plate cylinder 10. Most of the printing presses follow this general configuration with the only difference being the number of individual rollers and/or drums. A different printing press configuration can be seen in FIG. 2. This press is similar in design as the one shown in FIG. 1 but with the addition of two additional drums 22.

Regardless of the design of the printing press the principle of offset printing is to meter ink from the ink well 24 to the plate cylinder 10. By adjusting the tolerances, or gaps, between the given rollers and drums in the press an operator can meter the amount of ink, or the thickness of the ink applied, to the plate cylinder 10. The printing rollers can be made from a solid material or can be made with a hollow core. FIGS. 3 and 4 show two different types of rollers that are used in the press shown in FIG. 2. FIG. 3 shows a partial cut away view of an upper idler roller 18 made out of a solid block of metal, typically aluminum. FIG. 4 shows cross-sectional view of an upper form roller 12 made from a hollow core of metal that is also typically made out of aluminum.

In FIG. 3 the idler roller 18 consists of a roller portion 30, a flanged portion 32 and a journal 34. The roller portion 30 is cylindrical in shape. Disposed on the outer surface of the roller portion 30 is a rubber material 36 that is vulcanized on to the roller portion 30. The journal 34 is designed to accept a bearing thereby allowing the roller to be connected to the printing press. This roller is typically made out of a solid cylindrical block of aluminum and then machined down to the shape shown in FIG. 3. The machining process requires a great deal of time and manufacturing costs to complete. The fact that the roller is made out of a solid block of material results in a high material cost for the roller. In addition, the solid core roller is heavier than a hollow core roller.

FIG. 4 displays a hollow core upper form roller 12. Typically a hollow roller is made from a hollow cylindrical tube of metal such as aluminum. The hollow core 38 is cut to length and the ends are machined to accept a bearing block 40. The bearing block 40 is made from a metal material, such as aluminum, and is pressed into the end of the hollow core 38. A typical ball bearing 26 is made from a metal material such as steel and pressed into the bearing block 40. A rubber layer 36 is disposed on the outer surface of the hollow core 38. Although hollow core rollers do not have the high material expense as solid core rollers, some hollow core rollers do have high machining costs required to machine the core and bearing units.

Both of the rollers shown in FIGS. 3 and 4 are designed for resurfacing, or recovering, after the rubber is worn. Typically the rubber is worn over several uses of the printing roller or by operator error. The printing process requires the rollers to spin at high rates of speed and to be in contact under pressure. Consequently, as the printing press operates, the rubber on the rollers becomes worn and will be required to be replaced, which is an expensive process. The resurfacing process begins by having the operator remove the worn roller from the printing press and setting it aside for future shipment to the manufacturer of the printing roller, or a resurfacing house, for resurfacing. Alternatively, the resurfacing house can pick up the rollers at the printer. Either way, the printing roller is resurfaced with a fresh piece of rubber and returned to the printer. The resurfacing of the roller is a significant cost. In addition to the resurfacing house's fees and shipping cost, there are also administration costs and logistics related to the collecting, shipping, receiving and storing of the resurfaced printing rollers. There is significant time and cost associated with the resurfaced rollers as one needs to store the rollers in a spare location and inventory each roller type. Typically in a printing house using resurfaced rollers the printer operator needs to first removed the roller from the press and place it in a safe location. Unfortunately, this is not always done because at the time a worn roller is removed from the press the operator is generally busy or simply forgets and the roller can be misplaced or potentially lost. If the roller is not lost a second individual is usually charged with the duty of collecting the rollers for shipment to the resurfacing house. When the rollers are returned from the resurfacing house this person then has to inventory the roller and needs to maintain the stock of each roller to ensure that the printer has enough rollers of each type to keep the printing presses running. The above referenced work requires time and labor, both of which are an expense for the printer.

The present invention overcomes the obstacles of the prior art, as it is a disposable printing roller. The above-mentioned high administrative time and costs associated with a non-disposable roller are eliminated with the present invention. The operator merely disposes the printing roller once the rubber has become worn. The administrative costs and time attributed to resurfacing rollers and inventorying the same are eliminated. The invention comes in many designs depending on the application required; presently, there are two main applications. The first design can be seen in FIGS. 6, 7 and 7A. FIGS. 7 and 7A show the completed invention. FIG. 6 shows the essential elements of the invention. The hollow core 50 is made from an inexpensive metal such as steel. Alternatively, the hollow core 50 could also be made out of aluminum. The end caps 52 are made from a casting and then machine clean. The casting of the end caps 52 saves money in the manufacturing costs as one does have the increased labor cost involved with extensive machining an end cap as with the prior art (see FIG. 3). The each end cap 52 is pressed into each end of the hollow core 50. As with the prior art the rubber 54 is disposed on the outside surface of the hollow core 50 using standard vulcanization of rubber techniques. The printing roller can also be made with the inclusion of an internal bearing housing as shown in FIGS. 5, 5A and 5B. The present invention can be manufactured and sold for a cost similar to the cost of resurfacing an existing non-disposable roller.

### SUMMARY OF THE INVENTION

The present invention is directed to disposable printing rollers for the offset printing industry. More specifically, the present invention is designed for the flexographic industry for printing cups, containers, buckets, lids, etc. The novel design incorporates the same strength and durability as present non-disposable printing rollers without the high cost and maintenance. The invention provides the ease of single use rollers at the cost of most resurfacing roller costs. The invention comes in different styles depending on the application and the printing press used.

In one form the invention possesses end caps that are designed to hold a bearing so that the printing roller can be interfaced with the printing press. Another design has an internal bearing housing so that it too can be interfaced with the printing press. Both designs incorporate the cost savings of a hollow core roller.

Accordingly, one object of this invention is to provide an inexpensive disposable printing roller for the flexographic printing industry for printing plastic cups, containers, buckets, lids, etc.

Another object of this invention is to provide a disposable printing roller to streamline the printing process by eliminating the need to have the roller resurfaced each time the rubber is worn.

A third object of this invention is to streamline the management of the printing industry by not requiring and needing to inventory the rollers that need to be resurfaced, inventorying the resurfaced rollers and the requirement of a staging area for resurfaced rollers.

Other objects and advantages of this invention will become apparent from the following detailed description taken in conjunction with the accompanying drawings.

### BRIEF DESCRIPTION OF THE DRAWINGS

These and other features, aspects and advantages of the present invention will become better understood with reference to the following description, appended claims, and accompanying drawings where,

FIG. 1.0 is a cross-sectional view of an existing printing press,

FIG. 2.0 is a cross-sectional view of an existing printing press,

FIG. 3.0 is a partial cut away plan view of a prior art printing roller (solid core design),

FIG. 4.0 is a cross-sectional view of a prior art printing roller (hollow core design),

FIG. 5.0 is a cross-sectional view of the invention (internal bearings version),

FIG. 5.0A is a detail partial cross-sectional of the notch area (internal bearings version),

FIG. 5.0B is an end plan view of the invention (internal bearings version),

FIG. 6.0 is an exploded plan view of the invention (external bearings version),

FIG. 7.0 is a cross-sectional view of the invention (external bearings version),

FIG. 7.0A is an end plan view of the invention (external bearings version),

FIG. 8.0 is a plan view of an end cap (external bearings version).

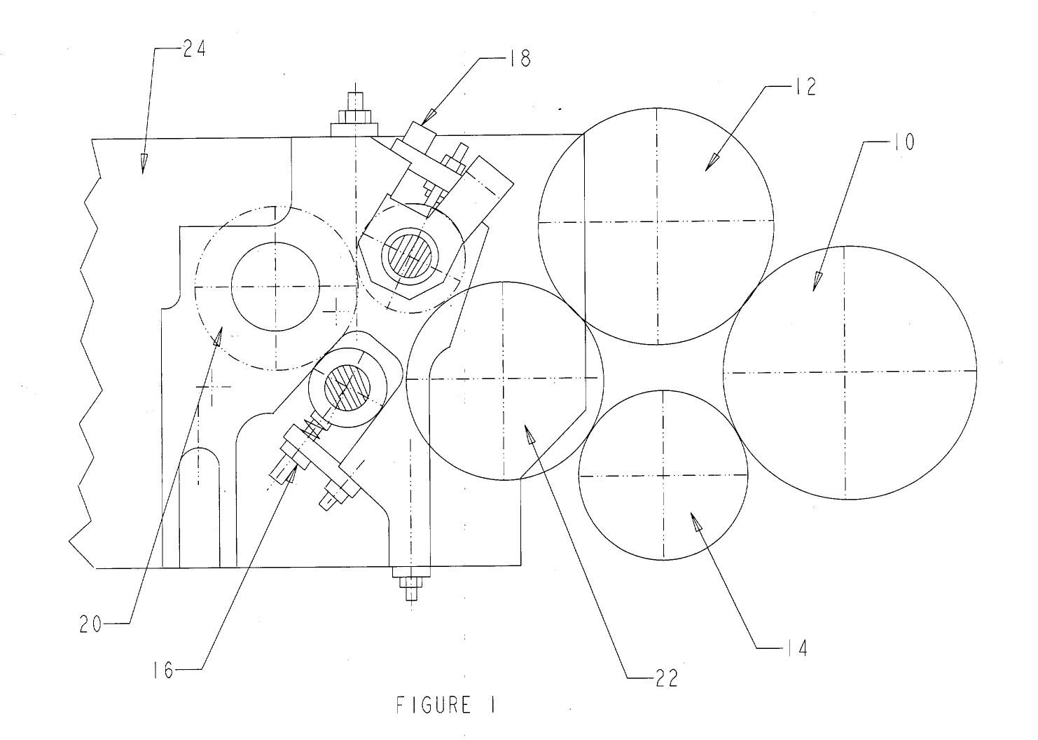

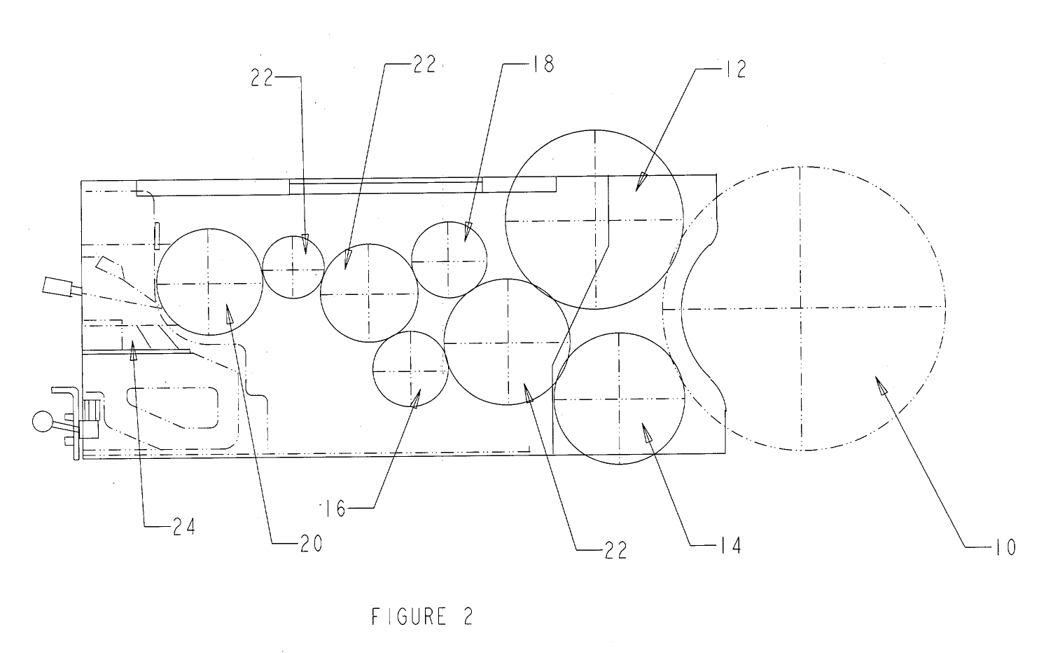

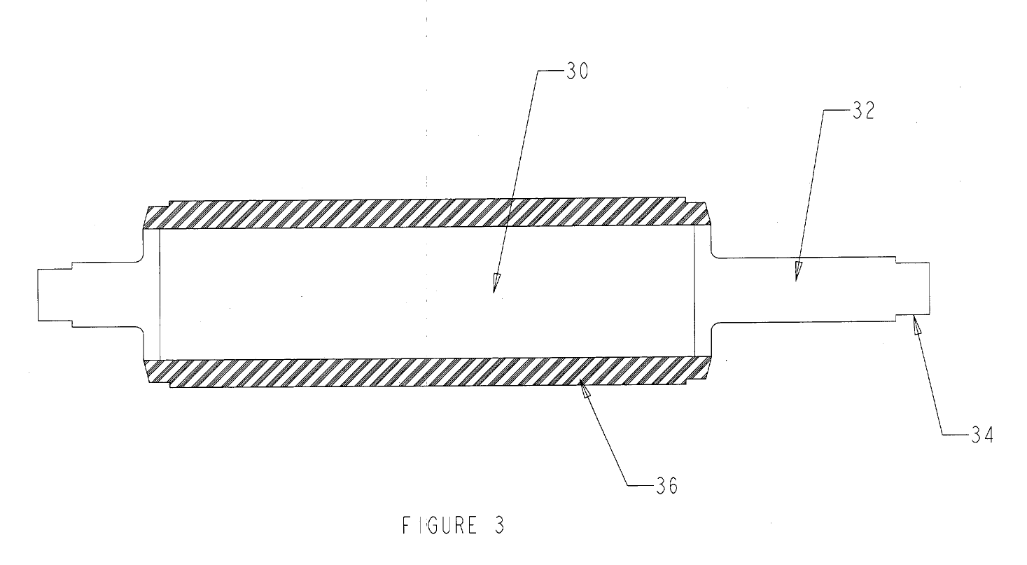

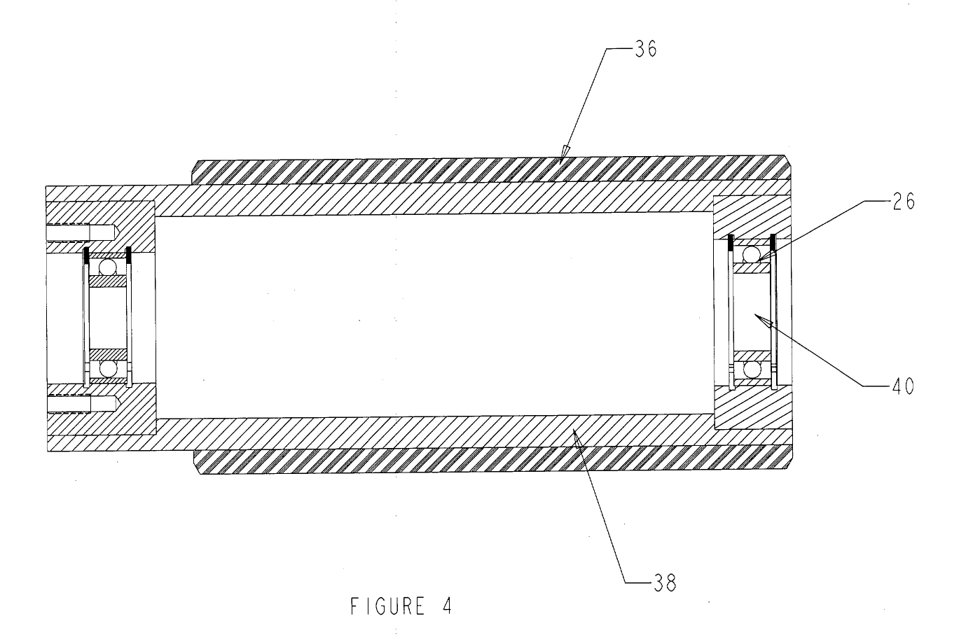

### DETAILED DESCRIPTION OF THE PREFERRED EMBODIMENT

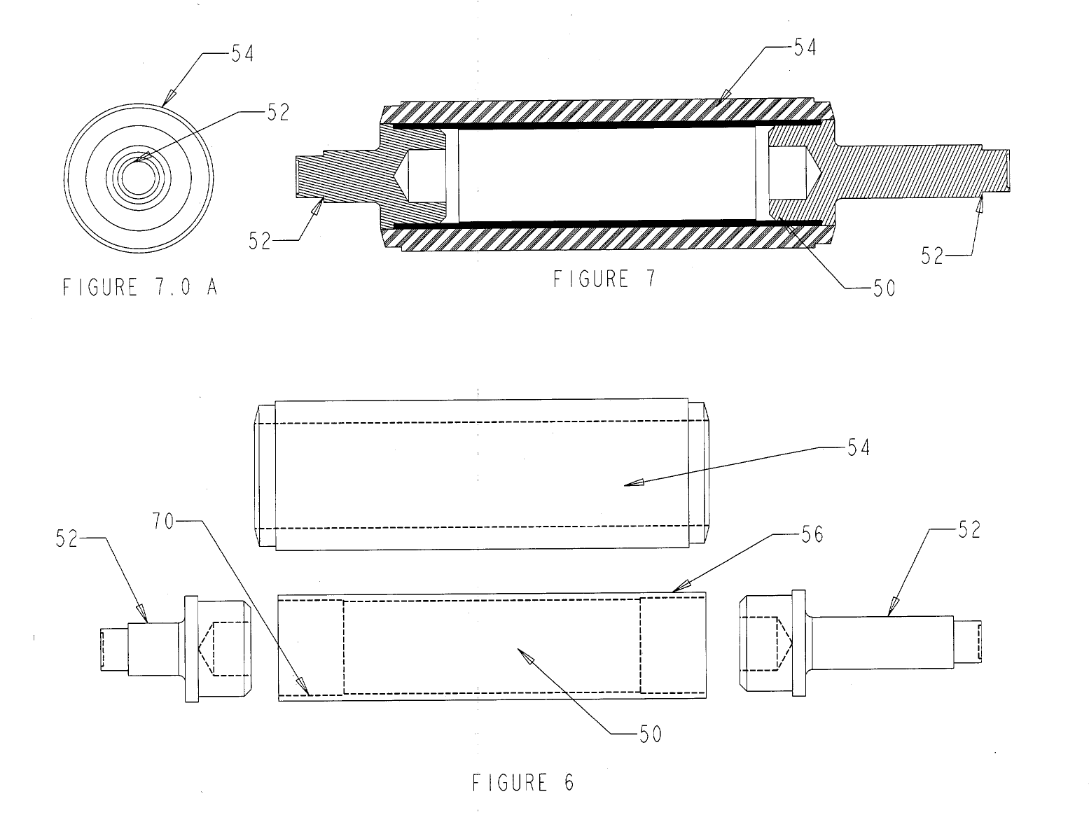

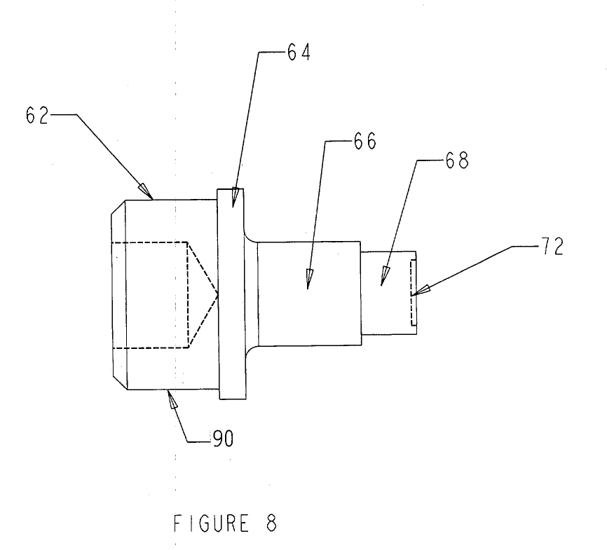

Referring to the Figures and more specifically FIGS. 6, 7 and 7A, the invention consists of a hollow core 50 made from a strong and inexpensive metal with the preferred embodiment being steel. The hollow core 50 may also be made out of aluminum. The hollow core 50 is cylindrical in shape and has an inner diameter and an outer diameter. There is an opening at each end of the hollow core 50. The hollow core 50 has an inside surface 70 and an outside surface 56. Disposed on the outside surface 56 is a layer of rubber 54. The rubber 54 can be attached to the outside surface 70 of the hollow core 50 using standard rubber vulcanization techniques.

The invention also consists of two end caps 52 that are designed to work in conjunction with the hollow core 50. There is a right end cap and a left end cap. Referring to FIG. 8 the end cap consists of a protrusion 62, a flange 64, an extension 66 and a journal 68 containing a slot 72. The protrusion 62 has an outer surface 90 and is specifically designed to engage with the inner surface 70 of the hollow core 50. The flange 64 is designed to work as a stop for the end cap 52 into the hollow core 50. To accomplish this the diameter of the flange 64 is larger than the inner diameter of the hollow core 50 so that the flange 64 will rest against the hollow core 50 once the end cap 52 is disposed within the hollow core 50.

The extension 66 holds the journal 68 that is designed to accept a bearing so that the invention can be used in a standard offset printer. The bearing is pressed onto the journal 68 using standing pressing techniques. The slot 72 in the journal 68 is designed to hold a “C” ring to hold the bearing on the roller. Alternative, the slot 72 is not machined into the journal 68 and the bearing is secured to the journal 68 by swaging over the end of the journal 68 onto the side of the bearing. The only difference between the two end caps 52 is the length of the extension 66.

Each end cap 52 is cast into it shape using standard casting techniques. The preferred embodiment of the end cap 52 is made from a strong but inexpensive metal such as steel. Alternatively, the end cap 52 could be made from aluminum or a strong plastic material such as thick walled nylon. The end cap 52 is pressed into hollow core 50 such that the outer surface 90 of the protrusion 62 is engaged with the inner surface 70 of the hollow core 50. The outside diameter of the outer surface 90 of the protrusion 62 is a few thousands of an inch larger than the inner diameter of the inner surface 70 of the hollow core 50 thereby ensuring a tight and press fit.

To assembly the invention one simply adds the appropriate bearing on the end of the journal 68 and a C-ring is disposed in the slot 72. Alternatively, the end of the journal 68 can be swaged over to secure the bearing to the journal 68. Once both bearings are placed and secured onto the end caps the invention is ready to be placed in the appropriate location in the printing press. Once the rubber becomes worn such that the roller is not efficient, the roller is simply removed and discarded. There is no longer a need to keep a stockpile of new and resurfaced rollers on hand. One can simply purchases the roller once and has a simple inventory of single use rollers on the shelf which can be used as necessary. Once the inventory of a given roller is near depletion the manager simply orders more rollers of that given type. No longer is there a need, or the costs associated with, the retaining of rollers and the administration logistics and costs associated with having them resurfacing and inventoried.

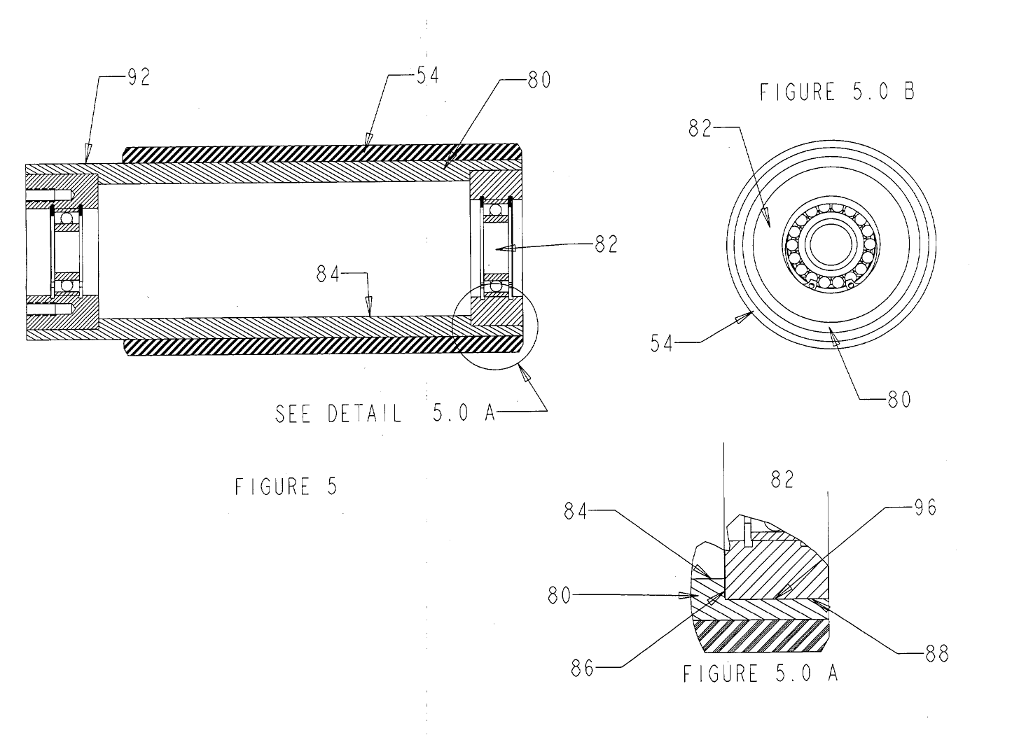

FIGS. 5, 5A and 5B display a version of the invention with internal bearings as presently required by some printing presses. The concept and design is the same as the other version of the invention but the bearings are contained in a bearing housing 82 which itself is disposed within the hollow core 80 of the roller. As with the prior version there is a hollow core 80 that is made from an inexpensive material such as steel. Alternatively, aluminum could be used for the hollow core 80. The hollow core has an inner surface 84 and an outer surface 92. The rubber 54 is vulcanized on to the outer surface 92 of the hollow core 80. The hollow core 80 is made from a cylindrical tube and therefore has to two open ends. Each open end is machined such that a notch is created to accept the bearing housing 82. The notch has a diameter that is greater than the inner diameter of the hollow core 80. The notch is machined from the hollow core 80 until a stop 86 is created. The stop 86 provides a means to secure and stop the bearing housing 82 inside the hollow core 80. The notch has a surface 88 that is designed to interface with the outer surface 96 when the bearing housing 82 is disposed in the notch. The bearing housing 82 may be cast using standard casting techniques. The bearing housing may be made from any strong metal such as steel or aluminum. The outer diameter of the bearing housing 82 is a few thousands larger than the diameter of the notch so that a tight and press fit is achieved when the bearing housing 82 is disposed within the notch. The bearing housing 82 is simply pressed using standard pressing techniques into the notch of the hollow core 80 until it rest against the stop 86. Once both bearing housings have been pressed into the roller, the roller is complete and ready for use in a printer.

What is claimed is:

1) A hollow core having two opening ends, an outer surface and an inner surface, an outer diameter and an inner diameter;
two end caps each having a protrusion portion, flange, extension and journal;
where the protrusion portion of each end cap having an outer surface and an outer diameter that is larger than the inner diameter of hollow core;
where each end cap is designed to be connected to the hollow core by the protrusion portion engaging with and disposing within an open end of the hollow core with the flange providing a stop for the end cap;
where the journal is designed to accept and secure an appropriate bearing so that the roller can be interfaced with a printing press;
where rubber is vulcanized to the outer surface of the hollow core.

2) A Disposable Printing Roller as in claim 1 where the bearing is secured to the journal be swaging over the latter so that it secures the former.

3) A Disposable Printing Roller as in claim 1 where there is a slot disposed within in the journal designed to accept a C-ring to secure the bearing on the journal.

4) A Disposable Printing Roller as in claim 1 where the hollow core is made from steel.

5) A Disposable Printing Roller as in claim 1 where the hollow core is made from aluminum.

6) A hollow core having an outer surface and inner surface, an outer diameter and an inner diameter, and two opening ends each containing a notch;
where the diameter of the notch is greater than the inner diameter but less than the outer diameter of the hollow core;
where the notch is designed to accept a bearing housing having an outer diameter that is larger than the inner diameter of the notch and where bearing housing is disposed within the notch;
where rubber is vulcanized to the outer surface of the hollow core.

7) A Disposable Printing Roller as in claim 6 where the hollow core is made from steel.

8) A Disposable Printing Roller as in claim 6 where the hollow core is made from aluminum.
